(19) United States
(12) Patent Application Publication
(10) Pub. No.: US 2021/0021170 A1
(43) Pub. Date: Jan. 21, 2021

(54) CONNECTION OF "N" BUSBARS IN AN ELECTRIC MOTOR

(71) Applicant: Schaeffler Technologies AG & Co. KG, Herzogenaurach (DE)

(72) Inventor: Matthias Gramann, Renchen (DE)

(73) Assignee: Schaeffler Technologies AG & Co. KG, Herzogenaurach (DE)

(21) Appl. No.: 16/981,809

(22) PCT Filed: Mar. 5, 2019
(86) PCT No.: PCT/DE2019/100194

§ 371 Date: Sep. 17, 2020

(30) Foreign Application Priority Data
Mar. 20, 2018 (DE) 10 2018 106 461.6

(51) Int. Cl. H02K 3/50

(52) U.S. Cl. CPC H02K 3/50; H02K 2203/09

(57) ABSTRACT

The disclosure relates to an interconnection of cylindrical windings of an electric motor with “n” conductor rails for producing switching connections between the individual windings. The conductor rails are geometrically arranged in a few planes, wherein a plane is defined as a concentric layer relative to the winding and follows a constant radius, wherein conductor rails on the same plane cross that conductor rail on the other plane.

### CROSS-REFERENCE TO RELATED APPLICATIONS

This application is the U.S. National Phase of PCT Appln. No. PCT/DE2019/100194 filed Mar. 5, 2019, which claims priority to DE 10 2018 106 461.6 filed Mar. 20, 2018, the entire disclosures of which are incorporated by reference herein.

### TECHNICAL FIELD

The disclosure relates to an interconnection of cylindrical windings of an electric motor with four conductor rails, wherein said conductor rails serve as electrical conductor strips for producing switching connections between the individual windings.

### BACKGROUND

Interconnection types in 3-phase machines are already known from the prior art. For example, DE 103 28 720 A1 specifies an interconnection element for a multi-phase winding of an electrical machine composed of coils, in particular a brushless DC motor, which has an annular carrier made of an insulating material and conductor tracks arranged in the carrier for the electrical interconnection of the coils and winding phases. For the cost-effective production of a compact, small-sized interconnection element, the conductor tracks are formed from sheet metal parts, which are staggered edgewise radially behind one another and are inserted into the annular carrier offset one another in the circumferential direction. The sheet metal parts are configured so that the number of sheet metal parts of the same shape is as large as possible.

The use of interconnection types of a 3-phase machine with a wave winding, as has been done so far, has the disadvantage that the connection from the respective conductor rail to the wire considerably extends the stator axially, parallel to the motor axis, because three planes have to be used radially inside and the unbundling to the radially outside wires takes place on the end face. Alternatively, the unbundling can be carried out on cylinder planes which lie radially on the outside. These would ultimately increase the radial installation space. A combination of the two unbundlings is also a known type of connection. This involves partial unbundling on the end face and the remaining partial unbundling on the outer cylinder surfaces, which increases both the axial length and the radial installation space by the corresponding unbundling part.

Furthermore, for example, DE 10 2014 201 637 A1 discloses a method for producing a stator which has a plurality of stator poles and at least one conductor rail for electrically connecting the ends of the windings of different stator poles. The method is characterized in that the conductor rail is constructed in several parts and has several holding parts, on each of which at least one winding wire can be fixed, and a connecting part for electrically connecting the holding parts, and in that the holding parts are initially arranged on a carrier component prior to a winding process and then the winding process takes place, in which at least one winding wire is wound onto stator teeth and fixed to the holding parts. After the winding process, the conductor rail is put together in that the holding parts are connected in an electrically conductive manner by means of the connecting part.

DE 102 61 611 A1 also discloses an interconnection element for a multi-phase winding composed of coils of an electrical machine, in particular a brushless small motor, which has a carrier made of insulating material and electrical conductor strips arranged on the carrier for establishing circuit connections between the coils. To reduce the material costs, the conductor strips are designed as bent wires, which are preferably inserted into grooves formed in the carrier and fixed by means of two annular cover elements made of insulating material.

### SUMMARY

The object of the present disclosure is to provide an interconnection for conductor rails which makes it possible to reduce both the axial and the radial dimensions. The use of such an interconnection in an electric motor is intended to save installation space while maintaining the same output. In particular, the disadvantages known from the prior art should be eliminated or at least reduced.

The object of the disclosure is achieved in a generic device according to the disclosure by geometrically arranging the preferably four conductor rails in a minimum number of preferably three planes, one plane being defined as a concentric layer relative to the winding and following a constant radius, with conductor rails on the same plane crossing the conductor rail on the other plane, i.e. the “unbundling” can take place as often as desired in said two planes. With this type of arrangement, the dimensions of the conductor rail areas for interconnecting a winding can be optimized. The result is a space-optimized solution. With a conductor rail distribution on the three planes mentioned, it is also possible to implement multi-phase motors, i.e. more than 3-phase motors.

By using such an interconnection and an adept crossing (unbundling) of the built-in planes, the interconnection can ideally be implemented and provided with almost no installation space and overall with only minimal extensions of the stator dimensions. In other words, assuming there are four conductor rails, two conductor rails that lie on one plane crossing the one conductor rail that is on the other plane. In the case of an inner rotor, as also illustrated by way of example in the drawing, the plane with the one individual conductor rail lies radially further inward than the plane with the two conductor rails. The fourth conductor rail has no influence on the outer or on the inner expansion of the radial dimensions and is described in more detail later.

Advantageous embodiments are claimed in the claims and are explained in more detail below

In the case of an inner rotor, for example, it is useful if the conductor rails are distributed radially on one side of the windings, e.g. on the outside of the windings/radially outside the windings, on more planes than radially on the opposite side of the winding, e.g. on the inside of the windings/radially inside the windings. In the case of an outer rotor, this can possibly be implemented in the opposite direction/vice versa. A radial extension to the outside in such a motor is advantageous, since this is installation space which is (in any case) somewhat more available inside the stator is the rotor, the largest possible design of which is advantageous so as to be able to benefit from a better torque. Thus, the necessary crossing of the interconnection is provided in several radial planes outwards. Of course, the internal components/planes can also be external or vice versa.

Furthermore, it is advantageous if the conductor rails arranged radially on one side, e.g. inside, are distributed on fewer planes than the conductor rails arranged radially in the opposite direction, e.g. radially outside, since these on a different plane and even on the other side of the windings. In this way, one plane less is installed inside the stator for four conductor rails than radially outside. The conductor rail areas for interconnection inside, which influence the radial dimension of the stator, must be designed to be minimal with regard to the radial installation space.

In other words, two cylinder planes/planes (running in the circumferential direction) are provided radially on the outside and only one “radial” plane, a cylinder plane, is formed radially inside the windings, again assuming four conductor rails, for example.

In particular, if a conductor rail is connected to a first end of a winding and is connected to a second end of another winding, wherein a bridge piece ensures the electrical connection of the conductor rails located on two different radial planes, wherein the bridge piece is arranged in a bridge level aligned perpendicularly to the radial planes, then the conductor rail areas for interconnecting the windings, which affect the axial length of the stator, are optimized. A minimal, axial extension has the advantage that the drive train can be kept shorter.

Another advantage arises when there are several bridge sections, for example three bridge sections, which are all arranged in the same bridge level. As a result, assuming the four conductor rails named above, only one bridge level for the four conductor rails is necessary in the axial dimension. Here, the fourth conductor rail already mentioned above lies in the one bridge level and connects the respective ends of the coils in this one (specific) bridge level. In other words, in the ideal case, the interconnection up to the one plane, including the fourth conductor rail, can be implemented axially above the end winding in a space-neutral manner and overall with minimal axial extensions of the stator.

It is preferred if the windings are designed as rod wave windings and/or the windings form 3×6 free ends due to the three strands per winding, each of which is designed with, for example, six wires.

It is also useful if the respective three strands are laser-welded to the respective ends of the conductor rails on the end face of the windings, wherein the end faces are slightly shortened axially or—in other words—can be accordingly embossed with the same result. This connection of the wires to the conductor rails means that the dimensions of the stator in the axial direction can remain unaffected.

One advantage of the interconnection is that the conductor rails are electrically separated from one another and/or from the windings assigned to the other conductor rails by at least one insulator.

Furthermore, it is advantageous if a stator built up by the windings is expanded in the radial direction inwards and outwards by the thickness of the conductor rail and the thickness of the insulation. In this way, each conductor rail can be guided in the respective cylinder planes insulated from the other conductor rails and insulated from the windings, which are surrounded by the conductor rails in a radial view, such that they cannot interfere with one another or inadvertently touch. In other words, interactions between the conductor rails can be prevented. The thickness of the insulation to be used can be adeptly adapted to the prevailing conditions and thus has only a small influence on the increase in radial dimensions.

The interconnection also has an advantage if the stator is expanded in the axial direction by the thickness of the bridge piece and the thickness of the insulation. This is a minimal extension of the stator in the axial direction. Here, too, each conductor rail can be guided as a bridge piece in the bridge level, insulated from the other conductor rails or windings.

It is preferred if the conductor rails of one plane are designed such that they are arranged closer to the windings than the intersecting conductor rails of the other plane. In this way, both installation space and material are saved.

The disclosure also relates to an electric motor with the interconnection according to the above aspects, the electric motor shown being a multi-phase, approximately 3-phase motor, but the solution presented can also be used for other phases.

### BRIEF DESCRIPTION OF THE DRAWINGS

The disclosure is explained below with the aid of a drawing: Wherein:

FIG. 1 shows a schematic plan view of the interconnection without showing the windings that are present in reality between “radial” planes accommodating conductor rails.

### DETAILED DESCRIPTION

The FIGURE is only schematic in nature and serves only for understanding the disclosure. The same elements are provided with the same reference symbols.

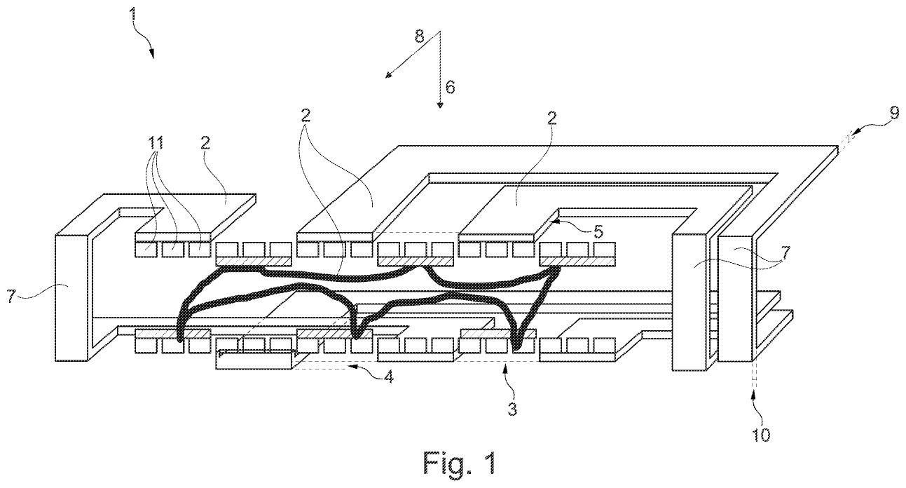

FIG. 1 shows a schematic plan view of the interconnection 1 of cylindrical windings of an electric motor. The interconnection 1 contains four conductor rails 2, each of which is connected with one end to a winding located on the radial inside of the stator and connected with the other end to another winding located on the radial outside of the stator.

Outside the stator, the three conductor rails 2 are arranged in two different planes 3 and 4 (cylinder planes themselves not shown). Two conductor rails 2 are provided on the same plane 3 and the third conductor rail 2 is provided on the other plane 4. The two conductor rails 2 shown on plane 3 cross the conductor rail 2 on plane 4.

On the radial inside of the stator, three conductor rails 2 are arranged in a plane 5 (cylinder plane itself not shown). The planes 3, 4 and 5 enlarge the stator in the radial direction 6.

The conductor rails 2 each merge into a bridge piece 7. The bridge pieces 7 lie in a common bridge level. The bridge level is perpendicular to planes 3, 4 and 5. Each bridge piece 7 connects the section of a conductor rail 2 running in the interior of the stator in the circumferential direction with the section of the same conductor rail 2 running outside the stator in the circumferential direction. The bridge level extends the stator in the axial direction 8.

In the bridge level, next to the bridge pieces 7, lies the fourth conductor rail 2, which also connects one end of one winding to another end of another winding.

Each conductor rail 2 has a thickness of the conductor rail 9. The thickness of the conductor rail 9, together with a required thickness of the insulation (not shown), defines the thicknesses of the respective planes 3, 4 and 5 and thus the extent of the dimensional increase. The thickness of the bridge level is defined by the thickness of the bridge rail 10 and the required thickness of the insulation (not shown).

Each winding consists of three strands 11 and each strand 11 comprises six wires (not shown). The windings and the way they are connected constitute a rod wave winding.

### LIST OF REFERENCE NUMBERS

1 Interconnection
2 Conductor rail(s)
3 Plane with two conductor rails
4 Plane with one conductor rail
5 Plane with three conductor rails
6 Radial direction of the stator
7 Bridge piece(s)
8 Axial direction of the stator
9 Thickness of conductor rail
10 Thickness of bridge piece
11 Strand

1. An interconnection of cylindrical windings of an electric motor with four conductor rails for establishing switching connections between individual windings, wherein the conductor rails are geometrically arranged in three planes, wherein one plane is defined as a concentric layer relative to the winding and follows a constant radius, with conductor rails on the same plane crossing that conductor rail on the other plane.

2. An interconnection according to claim 1, wherein the conductor rails are distributed radially on one side of the windings on more planes than radially on the opposite side of the windings.

3. An interconnection according to claim 1, wherein the conductor rails arranged radially on one side are distributed over fewer planes than the conductor rails arranged radially opposite thereto.

4. An interconnection according claim 1, wherein a conductor rail is connected to a first end of one winding and is connected to a second end of another winding, wherein one bridge piece ensures an electrical connection of the conductor rail located on two different radial planes, wherein the bridge piece is arranged in a bridge level aligned perpendicularly to the radial planes.

5. An interconnection according to claim 4, wherein there are “n” bridge pieces which are all arranged in the same bridge level.

6. An interconnection according to claim 4, wherein the conductor rails are electrically separated from each other and/or from the windings assigned to the other conductor rails by at least one insulator.

7. An interconnection according to claim 6, wherein a stator built up by the windings is expanded in a radial direction inwards and outwards by a thickness of the conductor rail and a thickness of the insulation.

8. An interconnection according to claim 7, wherein the stator is expanded in an axial direction by the thickness of the bridge piece and the thickness of the insulation.

9. An interconnection according to claim 1, wherein the conductor rails of one plane are designed in such a way that they are arranged closer to the windings than the conductor rails of the other plane.

10. An electric motor with the interconnection according to claim 1, wherein the electric motor is a multi-phase motor.
